(19) United States
(12) Patent Application Publication
(10) Pub. No.: US 2007/0059673 A1
(43) Pub. Date: Mar. 15, 2007

(54) Health management cuff

(76) Inventor: Chelsea Charles, Cordova, TN (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/600,371

(22) Filed: Nov. 16, 2006

Related U.S. Application Data
(63) Continuation-in-part of application No. 10/951,152, filed on Sep. 27, 2004, now Pat. No. 7,153,138.
(60) Provisional application No. 60/506,542, filed on Sep. 26, 2003.

(51) Int. Cl. G09B 19/00

(52) U.S. Cl. 434/127; 434/203; 235/61 R

(57) ABSTRACT

A cuff for a health managing system includes a strand having first and second terminal ends. A plurality of beads, each presenting a numerical or a non-numerical value, are slidably retainable and movable along the strand. A key extending from the strand and a keyway defined in each bead are movable between various positions to selectively allow movement of the beads between the first and second terminal ends for tabulating a health management system or preventing movement of the beads between the first and second terminal ends.

### RELATED APPLICATIONS

This application is a continuation in part application of the U.S. patent application Ser. No. 10/951,152 filed Sep. 27, 2004, which claims the benefit of U.S. Provisional Application Ser. No. 60/506,542 filed Sep. 26, 2003, both of which are incorporated herewith by reference in their entirety.

### FIELD OF THE INVENTION

The subject invention relates generally to an accessory item and, more particularly, to a dieting aid or a dieting system inclusive of a calorie-counting bracelet.

### BACKGROUND OF THE INVENTION

Today, people are heavier than ever before. Poor diet and physical inactivity, two major contributors to obesity, are closing in on tobacco use as the leading preventable causes of death in the United States, according to a report in March in the Journal of the American Medical Association. Also, since people place so much emphasize on appearance, often added pounds create a negative self-image resulting in depression and an overall lack of motivation to better their lives. When the money spent attempting to fix the health-related damages of obesity is added with that spent on our society's constant desire to be svelte, it equals a multi-billion dollar weight-loss industry. People will go to extremes to lose weight; attempting things like, juice fasts, life-threatening diet pills, fad diets, and exercise binges.

But, despite the miracle-promising weight loss scheme introduced each day, people continue to gain weight at an alarming rate. Usually two things happen when they embark on the fad diet. First thing relates to loss of interest because the diet method or tool cannot fit into their everyday lives. Second, even if weight is lost, it eventually returns with a vengeance due to boredom or exhaustion with the weight-loss tool and/or program. So despite the miracle promises, the only proven, sure ways to lose weight and keep it off are a combination of exercises and combined monitoring of both calorie and carbohydrate consumption. Fitness experts recommend keeping a food diary to write down everything, as soon as it is consumed. There are also software programs and electronic adding machines to count the number of calories if one knows the content of the items consumed. Unless there is a visible, constant reminder throughout the day, these tools won't be utilized. In order for a weight loss tool to be successful in this fast-paced, image-driven society it must adapt to people of different lifestyles and fashion tastes, at different stages of their lives; promote health and discipline without resulting in extreme deprivation.

Various dieting devices and methods have been taught by the U.S. Pat. No. 5,338,202 to Saari; U.S. Pat. No. 5,382,165 to Knox; U.S. Pat. No. 5,915,854 to Burke et al.; U.S. Pat. No. 5,796,640 to Sugarman et al.; and U.S. Pat. No. 6,341,295 to Stotler. One such example, disclosed in the U.S. Pat. No. 5,338,202 to Saari, teaches a planner having a foldable carrying case with a plurality of pockets and pocket inserts, or meal insert cards on and in the inside walls of the carrying case. Each meal insert cards identifies a specific meal type such as, for example, a dinner or a breakfast. A plurality of food cards each listing one specific food within a food exchange and displaying a picture of either the approximate or visual serving size of the food. A user selects the food cards each listing one specific food and places them in the pockets for the type of the meal. One of the prime shortcomings of the aforementioned calorie counting devices is their unattractiveness and blatant purpose. Most people today simply do not want to advertise the fact that they are dieting, let alone wear an unattractive numeric-indicator or planner for displaying the thousands of calories consumed in a day.

Alluding to the above, a bracelet, taught by the U.S. Pat. No. 6,561,415 to Grant, tried to solve the aforementioned problem. The bracelet includes sliding attached beads, intermittent “summing” beads, and a printed plastic wallet card that indicates the bead values for commonly eaten foods. The beads are assigned a value of 100 calories per bead and are subdivided into groups of summing beads. For every 100 calories consumed, one bead is moved across the bracelet. The bracelet taught by the U.S. Pat. No. 6,561,415 to Grant does not prevent the backwards and/or forward movement of beads, which results in uncontrolled movement of the beads through strenuous exercise or daily routine. In addition, the bracelet is unattractive and does not work with every type of outfit for a variety lifestyles. In addition, a tracking space defined between the beads is about half on an inch, which results in an unpleasantly looking bracelet.

But even, if it is practicable, it would be desirable to provide an improved bracelet or a cuff that fully prevents the backwards and/or forward movement of beads, thereby controlling “bead slide” created by through strenuous exercise or daily routine. It would also be beneficial to present an attractive accessory to work with every type of outfit for variety of lifestyles.

### SUMMARY OF THE INVENTION

A health management cuff of the present invention includes a strand having first and second terminal ends. A plurality of beads are retained on the strand and are slidably movable between the first and second terminal ends. A key in a shape of a tab is integral with and extends from the strand presenting a dividing segment thereby dividing the strand into opposing strand sections and providing a difference in resistance to movement of the plurality of beads along the opposing strand sections from the dividing segment, thereby retaining the plurality of beads on one of the opposing strand sections.

Alluding to the above, each bead presents a side wall defining an opening to slidably receive the strand and at least one slot or keyway defined in the wall to receive the tab as the tab is aligned with the slot. The mechanical engagement between the tab extending from the strand and the slot defined in each of the bids of the inventive cuff allows the bid to pass through the tab as the bid moves from the first terminal end to the second terminal end to manipulate the backwards and/or forward movement of the beads, thereby controlling “bead slide” created by through strenuous exercise or daily routine.

An advantage of the present invention is to provide the cuff which is attractive and fits with every type of outfit for individuals' varying lifestyles.

Another advantage of the present invention is to provide the cuff which is a cost-effective, safe, and simple tool created to aid weight-loss and style for people of all ages.

Still another advantage of the present invention is to provide a health cuff or bracelet adaptable to count glasses of water, fruit/vegetable servings, golf swings, and the like.

### BRIEF DESCRIPTION OF THE DRAWINGS

FIG. 1 shows a health management cuff comprising a plurality of beads having slots defined therein and a tab extending from a strand of the cuff for controlling movement of the beads along the strand;

FIG. 2 shows a health management cuff of FIG. 1 with an arrow pointing to the direction of the movement of the beads along the strand;

FIG. 3 shows a sectional view of the bead and the strand of FIG. 1, engaged with one and the other in a blocking position with the tab of the strand being not aligned with the slot of the bead thereby preventing movement of the bead along the strand; and

FIG. 4 shows a sectional view of the bead and the strand of FIG. 1, engaged with one and the other in a sliding position with the tab of the strand being aligned with the slot of the bead to allow the bead to move along the strand.

### DESCRIPTION OF THE INVENTION

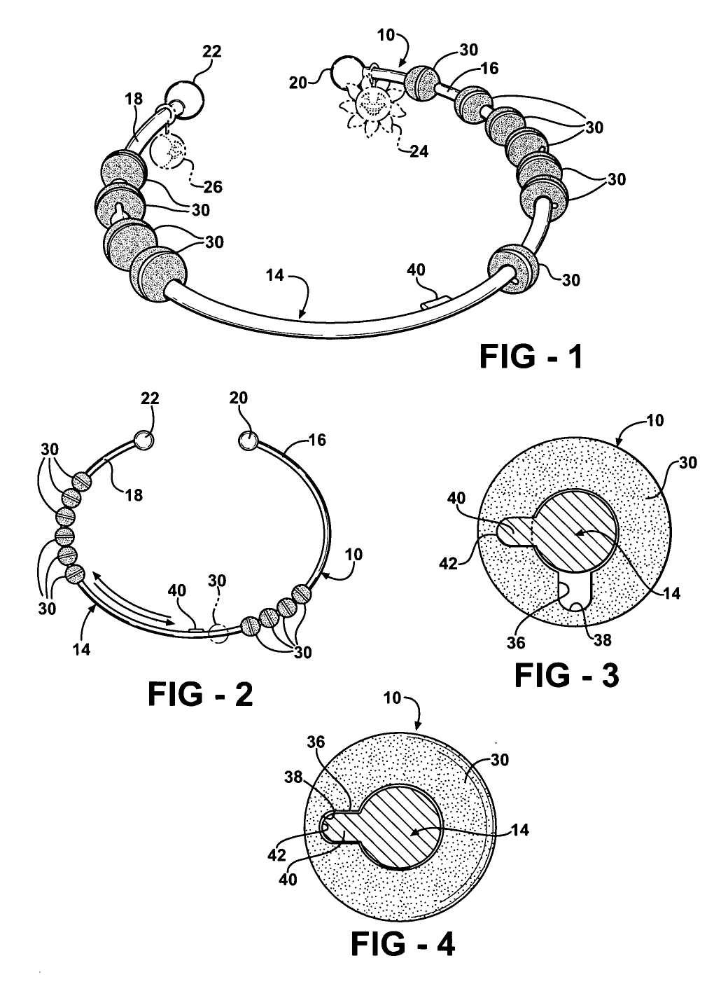

Referring to FIG. 1, an inventive health management cuff for a health management system is generally shown at 10. The cuff 10 includes a strand, generally indicated at 14 having first 16 and second 18 strand sections each presenting terminal ends 20 and 22, respectively. Preferably, the first and second strand sections 16 and 18 present a circular configuration. However, other configurations of the strand 14 are contemplated by the present invention. Preferably, each first and second strand sections 16 and 18 may include a charm bead, 24 of one kind, as shown in phantom, identifying a first part (A.M.) of a day and a charm bead of another kind 26, also shown in phantom, identifying a second part (P.M.) of the day. Both charm beads 24 and 26 are mechanically disposed at the respective terminal ends 20 and 22 to assist a user (not shown) in tabulating the health managing system when counting intake of the calories, or, for example, when taking a medicine.

As best shown in FIG. 2, a plurality of beads 30 or charms are retained along the strand 14 and are movable between the first and second strand sections 16 and 18. Preferably, the number of beads 30 is twenty to form the aforementioned health managing system, wherein each bead 30 signifies a fragmental numerical or non-numerical value of the health managing system. Alternatively, the number of beads 30 may be adjusted as the user may desire. For example, each bead 30 signifies 100 calories or a number of carbohydrates, depending on what phase the user is at his/her diet. As shown in FIGS. 3 and 4, each bead 30 includes a wall 32 defining an opening 34 adaptable to receive the strand 14 extending therethrough. At least one keyway or slot 36 is defined in the wall 32 and is exposed to the opening 34. The slot 36 presents a semi-circular bottom 38, as shown in FIGS. 3 and 4. The bottom 38 may present a non-circular configuration without limiting the scope of the present invention. Preferably, each bead 30 presents a round configuration, as shown in FIGS. 1 through 4. Alternatively, each bead 30 may present a form of a cube, a cylinder, or the like (not shown). Each bead 30 may be formed from a metal, a polymer, a wood, or the like.

Referring back to FIGS. 1 through 4, a dividing segment defined by a key or tab, generally indicated at 40 is disposed between first and second strand sections 16 and 18. The tab 40 is integrally formed with and extends outwardly from the strand 14. The tab 40 presents a semi-circular end portion 42 to compliment with the bottom 38 of the slot 36. The end portion 42 may present a non-circular configuration without limiting the scope of the present invention. As best illustrated in FIGS. 3 and 4, the bead 30 is movable between a first position, i.e. a sliding position, as the slot 36 is aligned with the tab 40 thereby allowing movement of the beads 30 between said first and second terminal ends 16 and 18 and a second position, i.e a blocking position, as the tab 40 and the slot 36 are not aligned with one another thereby preventing movement of the beads 30 between said first and second terminal ends 16 and 18.

Typically, the user counts calories ingested based on assigned quantitative caloric values of each bead 30. Once food is ingested, the user slides the appropriate number of beads 30 along the tab 40 from the first terminal end 16 to the second terminal end 18 of the cuff 10 for later count. At the end of the day, the user sums the total calories ingested through enumeration of beads 30 slid from one of the terminal end 16 of the cuff 10 to another terminal end 18 as compared with their assigned quantitative values. Finally, the user moves the counting beads 30 back to their original position to begin counting the next day. The cuff 10 may include a male connector and female connectors, not shown, at each connected to the first and second terminal ends 16 and 18 to mechanically engage the terminal ends 16 and 18 to form a loop. Such male and female connectors are further defined by a pair of opposite jump rings, known to those skilled in the art, to provide a convenient means of attachment between the first and second terminal ends 16 and 18.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A health management cuff comprising;
a strand having a first terminal end and a second terminal end,
a plurality of beads retained on said strand moveable along said strand between said first terminal end and said second terminal end, and
a key disposed upon said strand between said first terminal end and said second terminal end and each of said beads defining a keyway alignable with said key for moving said beads between said first terminal end and said second terminal end.

2. A health management cuff as set forth in claim 1 wherein said key is further defined by a tab being integral with and extending from said strand.

3. A health management cuff as set forth in claim 2 wherein each bead presents a wall defining an opening for receiving said strand.

4. A health management cuff as set forth in claim 3 wherein said keyway is further defined by at least one slot formed in said wall of each bead for receiving said tab passing therethrough with said slot exposed to said opening of said bead.

5. A health management cuff as set forth in claim 4 wherein said strand is formed from a metal.

6. A health management cuff as set forth in claim 5 wherein each bead signifies a fragmental value of a health management system.

7. A health management cuff comprising;
a strand having first and second terminal ends and a tab extending from said strand between said first and second terminal ends,
a plurality of beads retained on said strand for movement along said strand between said first and second terminal ends with each of said beads presenting at least one slot, and
each of said beads movable between a first position as said tab is aligned with said slot of each said bead thereby allowing sequential movement of said beads between said first and second terminal ends for tabulating a health management system and a second position as said tab and said slot are not aligned with one another thereby preventing movement of said beads between said first and second terminal ends.

8. A health management cuff as set forth in claim 7 wherein said strand and said beads are formed from a metal.

9. A health management cuff as set forth in claim 8 wherein each bead signifies a fragmental value of said health management system.
